(19) United States
(12) Patent Application Publication
(10) Pub. No.: US 2009/0129090 A1
(43) Pub. Date: May 21, 2009

(54) DISPLAY APPARATUS

(75) Inventor: Motoshige OKADA, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/251,812

(22) Filed: Oct. 15, 2008

(30) Foreign Application Priority Data
Nov. 20, 2007 (JP) 2007-300150

(51) Int. Cl. F21V 9/08

(52) U.S. Cl. 362/253

(57) ABSTRACT

The invention provides a display apparatus capable of performing display operation and light receiving operation on a pixel-by-pixel basis, and suppressing a decrease in aperture ratio or luminance. The display apparatus has a display element and a color filter, at least part of the color filter having a function as a photoelectric conversion element.

### CROSS REFERENCE TO RELATED APPLICATIONS

The present invention contains subject matter related to Japanese Patent Application JP 2007-300150 filed in the Japanese Patent Office on Nov. 20, 2007, the entire contents of which being incorporated herein by reference.

### BACKGROUND OF THE INVENTION

1. Field of the Invention

The present invention relates to display apparatuses such as liquid crystal displays and organic EL (electroluminescence) display apparatuses.

2. Description of the Related Art

In some display apparatuses of related art, a display cell including one display element and one light receiving cell including a light receiving element are formed in the individual pixels of a liquid crystal display or an organic EL display apparatus, so that display operation and light receiving operation can be performed on a pixel-by-pixel basis (for example, refer to Japanese Unexamined Patent Application Publication No. 2006-127212, [0034], [0062] and FIG. 1). The light receiving cell is an optical sensor circuit having a photoelectric conversion element such as a photodiode, as a light receiving element, and a TFT (thin film transistor) as a switching element. The photodiode is mounted on a transparent substrate together with a switching TFT.

### SUMMARY OF THE INVENTION

However, the photoelectric conversion element contributes neither to aperture ratio nor luminance with respect to the direct light from the backlight of a liquid crystal display apparatus, and with respect to the emitted light from the light emitting element of a spontaneous light emitting display device such as an organic EL or an LED (light emitting diode). The location of the photoelectric conversion element may cause the luminance decrease of the display apparatus.

It is desirable to provide a display apparatus capable of performing display operation and light receiving operation on a pixel-by-pixel basis, and suppressing a decrease in aperture ratio or luminance.

According to an embodiment of the present invention, there is provided a display apparatus having a display element and a color filter. At least part of the color filter has a function as a photoelectric conversion element.

In the display apparatus of the embodiment of the present invention, at least part of the color filter functions as a photoelectric conversion element, and therefore light permeability is imparted to the photoelectric conversion element, thereby suppressing a decrease in aperture ratio or luminance of the display apparatus. This enables display operation and light receiving operation on a pixel-by-pixel basis, also enables suppression of a decrease in aperture ratio or luminance.

Other and further objects, features and advantages of the invention will appear more fully from the following description.

### BRIEF DESCRIPTION OF THE DRAWINGS

FIG. 1 is a diagram showing the overall configuration of a display apparatus according to an embodiment of the present invention;

FIG. 2 is a diagram showing an example of the configuration of a display section shown in FIG. 1;

FIG. 3 is a sectional view showing the configuration of a display light-receiving cell shown in FIG. 2;

FIG. 4 is a sectional view showing another configuration of the display light-receiving cell; and

FIG. 5 is a sectional view showing another configuration of the display light-receiving cell.

### DESCRIPTION OF THE PREFERRED EMBODIMENTS

Preferred embodiments of the present invention will now be described in detail with reference to the accompanying drawings.

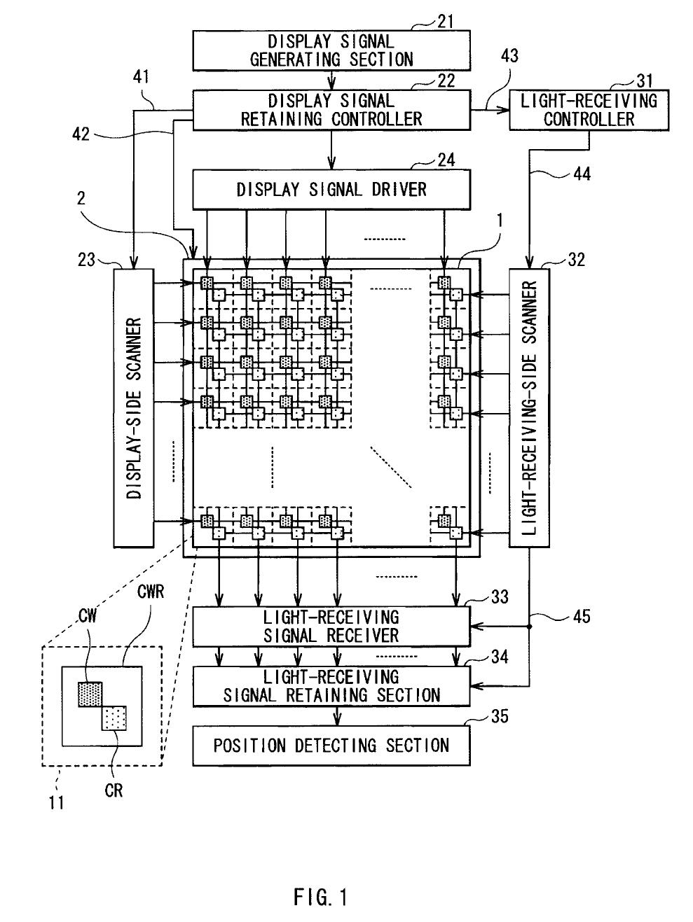

FIG. 1 shows the schematic configuration of a display apparatus according to an embodiment of the present invention. The display apparatus is a liquid crystal display apparatus for use in middle- and large-sized display apparatuses such as liquid crystal television sets, or mobile purposes such as cell phones or gaming machines. For example, the display apparatus has a display section 1, a backlight light source 2, a display signal generating section 21, a display signal retaining controller 22, a display-side scanner 23, a display signal driver 24, a light-receiving controller 31, a light-receiving-side scanner 32, a light-receiving signal receiver 33, a light-receiving signal retaining section 34 and a position detecting section 35.

The display section 1 has a plurality of pixels 11 arranged in a matrix form on the entire surface thereof, and displays images such as predetermined graphics and characters while performing line sequential operation. Each of the pixels 11 is formed by a display light-receiving cell CWR provided with a display cell CW including one display element and one light-receiving cell CR including a light-receiving element.

The backlight light source 2 is a light source for irradiating light to the display section 1, and includes, for example, an LED, a CCFL (cold cathode fluorescent lamp), or alternatively an organic or an inorganic EL element.

The display signal generating section 21 generates a display signal for displaying an image plane frame on a frame-by-frame basis, based on the data generated by a not-shown CPU (central processing unit) or the like and supplied from the CPU. The display signal generating section 21 supplies the generated display signal to the display signal retaining controller 22.

The display signal retaining controller 22 stores and retains, on a frame-by-frame basis, the display signals supplied from the display signal generating section 21, in a frame memory composed of an SRAM (static random access memory) or the like. The display signal retaining controller 22 also controls the operations of the display-side scanner 23 and the display signal driver 24 which drive the individual display cells CW. Specifically, the display signal retaining controller 22 supplies a display timing control signal 41 for instructing a display timing to the display-side scanner 23, and also supplies a display signal corresponding to one horizontal line to the display signal driver 24, based on the display signal retained in the frame memory. Further, the display signal retaining controller 22 controls the light emission timing in the backlight light source 2 by supplying a turn-on timing control signal 42 to the backlight light source 2. The display signal retaining controller 22 also controls the operation timing of the light-receiving controller 31 described later. Specifically, the display signal retaining controller 22 supplies the light-receiving controller 31 with a vertical synchronizing signal 43 indicating a frame timing, a signal indicating whether the backlight light source 2 is turned on, and a signal indicating whether the scanning of display selection signals of the entire display section 1 is terminated.

The display-side scanner 23 selects a display cell CW to be driven, in accordance with the display timing control signal 41 outputted from the display signal retaining controller 22. Specifically, the display-side scanner 23 supplies a display selection signal through a display gate line connected to the individual pixels 11 of the display section 1.

The display signal driver 24 supplies display data to a display cell CW to be driven, in accordance with the display signal corresponding to one horizontal line outputted from the display signal retaining controller 22. Specifically, the display signal driver 24 supplies, through a data supply line connected to the individual pixels 11 of the display section 1, a voltage corresponding to the display data to the pixel 11 selected by the display-side scanner 23.

The light-receiving controller 31 controls the light-receiving operation of the entire display section 1. Specifically, the vertical synchronizing signal 43, the signal indicating whether the backlight light source 2 is turned on, and the signal indicating whether the scanning of display selection signals of the entire display section 1 is terminated, are supplied from the display signal retaining controller 22 to the light-receiving controller 31. Based on any one of these signals, the light-receiving controller 31 supplies a light-receiving timing control signal 44 to the light-receiving-side scanner 32.

The light-receiving-side scanner 32 selects a driven light-receiving cell CR in accordance with the light-receiving timing control signal 44 outputted from the light-receiving controller 31. The light-receiving-side scanner 32 supplies a light-receiving selection signal to the individual pixels 11 of the display section 1 through a light-receiving gate line connected to these pixels 11. The light-receiving-side scanner 32 also controls the light-receiving signal receiver 33 and the light-receiving signal retaining section 34 by outputting a light-receiving block control signal 45 to the light-receiving signal receiver 33 and the light-receiving signal retaining section 34, respectively.

In accordance with the light-receiving block control signal 45 outputted from the light-receiving-side scanner 32, the light-receiving signal receiver 33 captures a light-receiving signal corresponding to one horizontal line outputted from each light-receiving cell CR. The light-receiving signal receiver 33 also outputs the captured light-receiving signal corresponding to one horizontal line to the light-receiving signal retaining section 34.

In accordance with the light-receiving block control signal 45 outputted from the light-receiving-side scanner 32, the light-receiving signal retaining section 34 reconfigures the light-receiving signal outputted from the light-receiving signal receiver 33 into a light-receiving signal per image plane frame, and then stores and retains the signal in a frame memory composed of an SPAM or the like. The light-receiving signal data stored in the light-receiving signal retaining section 34 are outputted to the position detecting section 35. Alternatively, the light-receiving signal retaining section 34 may be formed by a storage element other than memories, making it possible to retain, for example, the light-receiving signal data as analog data.

Based on the light-receiving signal data outputted from the light-receiving signal retaining section 34, the position detecting section 35 performs signal processing to specify the position of an object detected in the light-receiving cell CR, thus enabling to specify the position of a contacting or adjoining object (for example, a user's finger). When the light-receiving signal retaining section 34 stores the light-receiving signal data as analog data, the position detecting section 35 performs an analog/digital (A/D) conversion, followed by signal processing.

Alternatively, a drive (not shown) may be connected through an interface (not shown) to the display signal retaining controller 22 and the light-receiving controller 31 according to need. This drive is used to read a program stored in a mounted magnetic disk, an optical disk, a magneto-optical disk or a semiconductor memory, and supply the program to the display signal retaining controller 22 or the light-receiving controller 31.

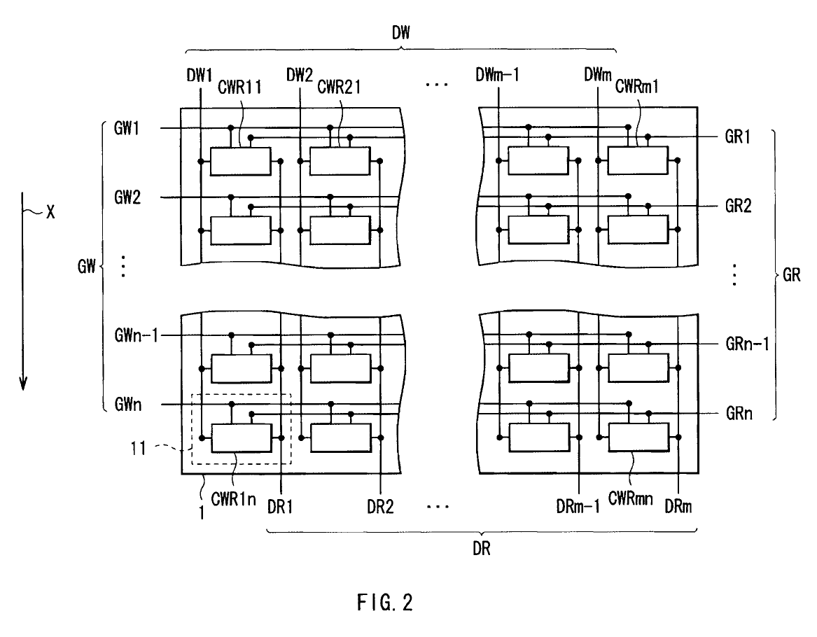

FIG. 2 is a diagram showing an example of the configuration of the display section 1. The display section 1 has pixels 11 arranged in a matrix form, for example, m pixels in a horizontal line direction and n pixels in a vertical line direction and a total of (m×n) pixels. For example, the display section 1 of XGA (extended graphics array) standard as a general display standard for PCs (personal computers) has m=1024×3 (RGB) and n=768 and a total of 2,359,296 pixels 11.

Each of the total (m×n) pixels 11 in the display section 1 includes display light-receiving cells CWR11 to CWRmn. Depending on the number of the pixels 11, the display section 1 is provided with m data supply lines DW (DW1 to DWm), m data read lines DR (DR1 to DRm), n display gate lines GW (GW1 to GWn) and n light-receiving gate lines GR (GR1 to GRn). In FIG. 2, the arrow X indicates the scan directions of the display gate lines GW and the light-receiving gate lines GR.

The data supply lines DW, the data read lines DR, the display gate lines GW and the light-receiving gate lines GR are connected to the display signal driver 24, the light-receiving signal receiver 33, the display-side scanner 23 and the light-receiving-side scanner 32, respectively. One data supply line DW, one data read line DR, one display gate line GW and one light-receiving gate line GR are connected to each of these display light-receiving cells CWR.

For example, one data supply line DW1 and one data read line DR1 are commonly connected to the display light-receiving cells CWR11, CWR12, . . . , CWR1n on one vertical line. For example, one display gate line GW1 and one light-receiving gate line GR1 are commonly connected to the display light-receiving cells CWR11, CWR21, . . . . , CWRm1 on one horizontal line.

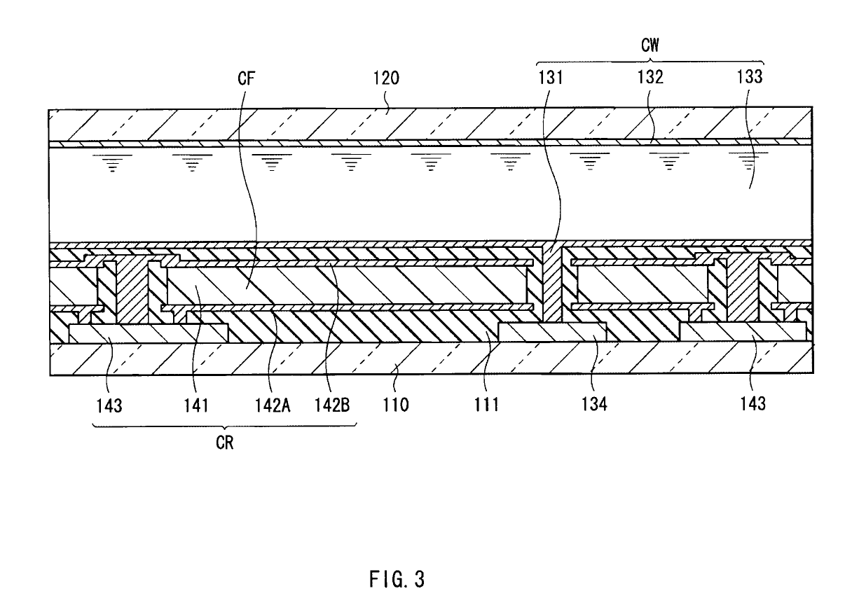

FIG. 3 shows an example of the sectional configuration of one display light-receiving cell CWR. The display light-receiving cell CWR has a display cell CW, a color filter CF and a light-receiving cell CR between a substrate 110 and an opposed substrate 120 each being composed of a transparent material such as glass.

The display cell CW is a liquid crystal display element having a liquid crystal layer 133 between a display element pixel electrode 131 mounted on the TFT substrate 110 and a display element common electrode 132 mounted on the opposed substrate 120. A display element transistor 134 is connected to the display element pixel electrode 131.

The light-receiving cell CR has, for example, a photoelectric conversion element 141 and a pair of photoelectric conversion element transparent electrodes 142A and 142B arranged oppositely with the photoelectric conversion element 141 in between. A light-receiving element transistor 143 is connected to the photoelectric conversion element transparent electrodes 142A and 142B, respectively.

The color filter CF enables color display in the display cell CW. The color filter CF contains a photoelectric conversion material, specifically a sensitizing dye, and has a function as the photoelectric conversion element 141 in the light-receiving element CR. Consequently, the display apparatus can perform display operation and light receiving operation on a pixel-by-pixel basis, and also suppress a decrease in aperture ratio or luminance.

The color filter CF is formed by allowing a sensitizing dye to be carried in a porous layer composed of an oxide semiconductor material.

As the oxide semiconductor material, any known ones are usable as long as the CB (conduction band) of the photoelectric conversion element 141 (the color filter CF) is lower than the LUMO of the sensitizing dye. Examples of the oxide semiconductor material include metal oxides such as Ti, Zn, Nb, Zr, Sn, Y, La and Ta, and perovskite-based oxides such as SrTiO₃ and CaTiO₃.

The sensitizing dye is composed of molecules exhibiting absorption in visible light region, having a functional group bonded to the oxide semiconductor material and causing rapid electron transfer from the optically excited state to the oxide semiconductor material. The sensitizing dye may be in any one of liquid state, gel state (semi-solid state) and solid state. Examples of the functional group bonded to the oxide semiconductor material include Ru(bby) complexes, porphyrin derivatives and coumalin derivatives having a carboxyl group, a sulfonate group or a hydroxyl group.

The display element pixel electrode 131, the display element common electrode 132 and the photoelectric conversion element transparent electrodes 142A and 142B are composed of a transparent conductive material such as ITO (indium tin oxide). The display element pixel electrode 131 and the display element common electrode 132 have an alignment film (not shown) formed on their respective surfaces. The liquid crystal layer 133 may be formed of any liquid crystal material.

The display element transistor 134 and the light-receiving element transistor 143 are formed of amorphous silicon TFT when they are used in middle- and large-sized display apparatuses such as liquid crystal television sets, and formed of low temperature polysilicon TFT when they are used in mobile purposes such as cell phones and gaming machines. No limitation is imposed on the compositions of these amorphous silicon TFT and low temperature polysilicon TFT. The data supply line DW and the display gate line GW (not shown in FIG. 3, see FIG. 2) are connected to the display element transistor 134. The data read line DR and the light-receiving gate line GR (not shown in FIG. 3, see FIG. 2) are connected to the light-receiving element transistor 143.

The display element transistor 134 and the light-receiving element transistor 143 are formed, for example, on the same surface of the substrate 110, and the color filter CF is formed on these transistors by interposing therebetween an insulating layer 111 composed of an OC (overcoat) material or a nitride film. Examples of the OC material include thermosetting resins such as epoxy resin and acrylic resin.

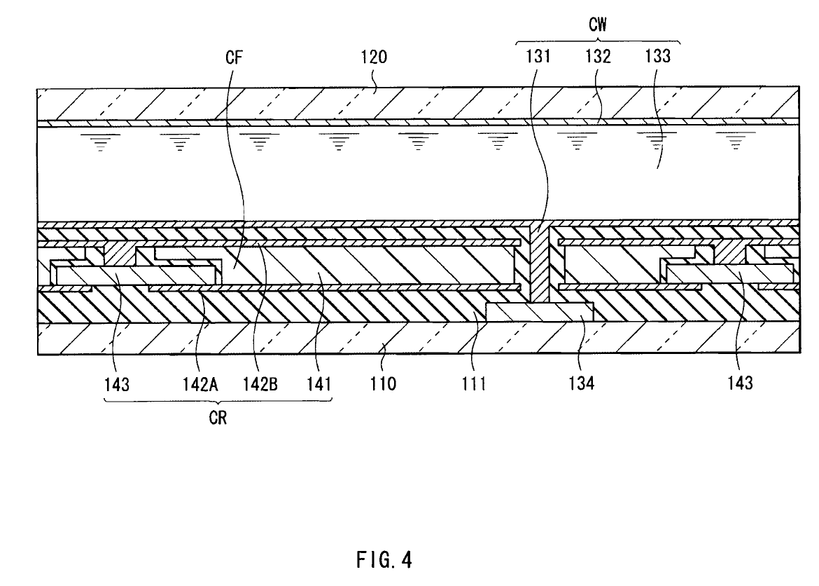

The positional relation of components among the display cell CW, the light-receiving cell CR and the color filter CF is shown in FIG. 3 by way of example and without limitation. Alternatively, as shown in FIG. 4, the display element transistor 134 may be formed on the substrate 110, and the color filter CF and the light-receiving element transistor 143 may be formed on the display element transistor 134 with the insulating layer 111 in between.

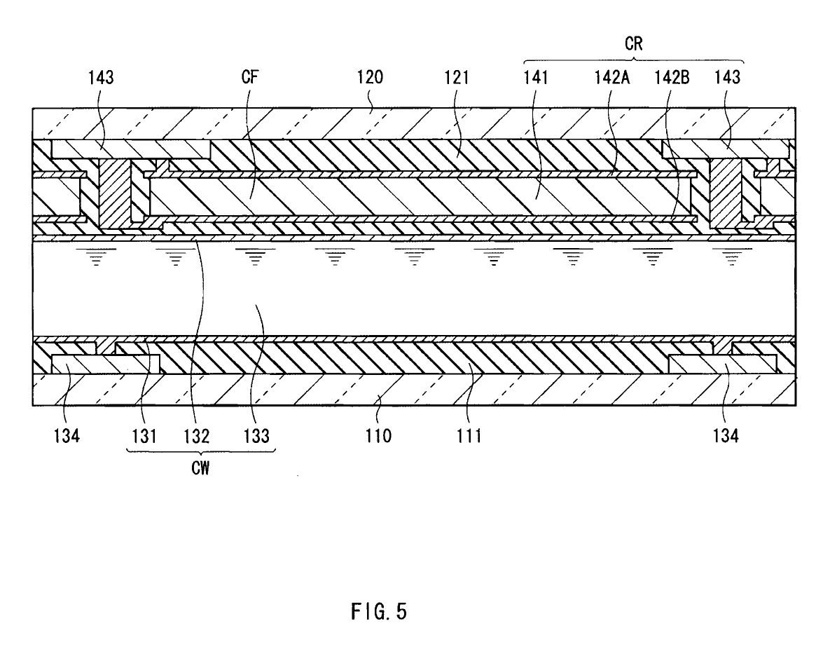

Alternatively, as shown in FIG. 5, the display element transistor 134 may be formed on the substrate 110, and the color filter CF and the light-receiving transistor 143 may be formed on the opposed substrate 120. In this case, the display element common electrode 132 is formed on the color filter CF and the light-receiving element transistor 143 by interposing therebetween an insulating layer 121 composed of the same OC material as the above-mentioned insulating layer 111. In the configurations as shown in FIGS. 3 to 5, the configuration shown in FIG. 4 seems to be formed in the easiest process, the configuration shown in FIG. 5 seems advantageous in yield, and the configuration shown in FIG. 3 seems advantageous in display performance.

The display apparatus of the invention may be manufactured in the following manner, for example. In the following, the case of manufacturing the display apparatus having the configuration shown in FIG. 3 will be described.

Firstly, according to the usual thin film semiconductor process, on a substrate 110 composed of the above-mentioned material, a display element transistor 134 and a light-receiving element transistor 143 are formed, and an insulating layer 111 composed of the above-mentioned material is formed thereon.

Subsequently, a photoelectric conversion element transparent electrode 142A composed of the above-mentioned material is formed and then connected through a connecting hole provided in the insulating layer 111 to the light-receiving element transistor 143.

Subsequently, a porous layer is formed on the photoelectric conversion element transparent electrode 142A by sintering semiconductor particles composed of the above-mentioned oxide semiconductor material. A sensitizing dye solution is prepared by dissolving the above-mentioned sensitizing dye in a solvent such as ethanol, methanol or toluene. While heating the substrate 110, the sensitizing dye solution is dropped onto the porous layer and then dried, so that the sensitizing dye is carried in the oxide semiconductor material, thereby forming a photoelectric conversion element 141 (a color filter CF).

Thereafter, the insulating layer 111 is formed around the photoelectric conversion element 141, and a photoelectric conversion element transparent electrode 142B is formed on the photoelectric conversion element 141. At this time, the photoelectric conversion element transparent electrode 142B is connected through a connecting hole provided in the insulating layer 111 to the light-receiving element transistor 143.

After forming the photoelectric conversion element transparent electrode 142B, an insulating layer 111 is formed thereon, and a display element pixel electrode 131 composed of the above-mentioned material is formed and then connected through a connecting hole provided in the insulating layer 111 to the display element transistor 134.

The opposed substrate 120 composed of the above-mentioned material is prepared, and the common electrode 132 composed of the above-mentioned material is formed on the surface of the opposed substrate 120. The substrate 110 and the opposed substrate 120 are arranged oppositely, and a sealing layer (not shown) is formed therearound. Then, a liquid crystal layer 133 is formed by injecting a liquid crystal in between these two substrates. Thus, the display apparatus shown in FIG. 3 is completed.

In the above display apparatus, when a display selection signal is applied from the display-side scanner 23 to a predetermined pixel 11, a display operation corresponding to a voltage supplied from the display signal driver 24 is performed in the pixel 11. Owing to the line sequential operation thus performed by the display-side scanner 23 and the display signal driver 24, the image corresponding to arbitrary display data is displayed on the display section 1.

When a light-receiving selection signal is supplied from the light-receiving-side scanner 32 to a predetermined pixel 11 in accordance with the light-receiving timing control signal 44 outputted from the light-receiving controller 31, a light-receiving signal corresponding to the quantity of light detected by the photoelectric conversion element 141 of the pixel 11 is outputted from the pixel 11 to the light-receiving signal receiver 33. The light-receiving signal is reconfigured into a light-receiving signal per image plane (on a frame-by-frame basis) and stored in the frame memory, and also outputted to the position detecting section 35 by the light-receiving signal retaining section 34. The position detecting section 35 performs signal processing to specify the position of the object detected in the light-receiving cell CR, based on the light-receiving signal data outputted from the light-receiving signal retaining section 34. This enables to specify the position of the contacting or adjoining object.

Here, the color filter CF is configured to have a function as the photoelectric conversion element 141 by containing, for example, the sensitizing dye as a photoelectric conversion material, so that light permeability is imparted to the color filter CF, thereby suppressing a decrease in aperture ratio or luminance of the display apparatus.

Thus, in the present embodiment, the color filter CF is configured to contain the sensitizing dye as the photoelectric conversion material and has the function as the photoelectric conversion element 141. This enables the individual pixels 11 to perform display operation and light receiving operation, and also suppress a decrease in aperture ratio or luminance. In particular, the application to the liquid crystal displays necessitates a less number of parts of the backlight light source 2 for ensuring luminance than the configuration of related art using a photodiode as a photoelectric conversion element.

Although the present invention has been described above based on the embodiment, various modifications may be made without limiting to the foregoing embodiment. For example, instead of the entire color filter CF, a part of the color filter CF may have a function as the photoelectric conversion element 141. Alternatively, only the color filter CF of a specific color (for example, blue) among red, green and blue color filters CF may have a function as the photoelectric conversion element 141. In this case, the photoelectric conversion element transparent electrodes 142A and 142B may be formed at the region having the function of the photoelectric conversion element 141 in these color filters CF. The light-receiving element transistor 143 may be connected through the photoelectric conversion element transparent electrodes 142A and 142B to the region having the function as the photoelectric conversion element 141 in these color filters CF.

In some reflection-transmission type liquid crystal displays, a part of the reflection section is not provided with the color filter CF for luminance correction purposes. The present invention is also applicable to the case where the color filter CF is arranged only a part of the display section 1. Also in this case, the entire color filter CF may have the function of the photoelectric conversion element 141, or alternatively only the color filter CF of a specific color (for example, blue) among red, green and blue color filters CF may have the function as the photoelectric conversion element 141.

The color filters CF may be provided for each pixel 11, or alternatively provided continuously over a plurality of pixels 11.

In the foregoing embodiment, the specific configurations of the entire display apparatus and the display section 1 have been described by way of example without limitation. For example, in the display light-receiving cell CWR, the display gate line and the light-receiving gate line are separately connected so that display operation and light-receiving operation may be performed independently of each other. The circuit configuration of the display light-receiving cell CWR is not limited to this.

Although the foregoing embodiment is directed to the case where the present invention is applied to the liquid crystal display apparatus, the present invention is also applicable to the cases of using other display elements such as an organic or inorganic EL, an FED (field emission display) or a PDP (plasma display panel). In particular, when applied to a spontaneous light emitting element such as an EL, a sufficient light emitting area can be ensured to suppress the necessary amount of current for obtaining the necessary luminance, thus leading to a longer lifetime thereof.

The present invention is widely applicable to various display apparatuses using color filters. Besides the display apparatuses, the present invention is also applicable to photosensors (image sensors) for converting light to electric signals, which are widely used in digital still camera, video cameras, biometrics identification sensors such as fingerprint sensors and vein sensors, facsimiles, scanners and copying machines. These image sensors (photosensors) of related art are formed on silicon wafers. As compared with these image sensors of related art, the present invention is advantageous in cost and enables them to be manufactured in the currently established process of manufacturing a film transistor. Hence, the applications to new communication instruments can also be expected.

It should be understood by those skilled in the art that various modifications, combinations, sub-combinations and alterations may occur depending on design requirements and other factors insofar as they are within the scope of the appended claims or the equivalents thereof.

What is claimed is:

1. A display apparatus having a display element and a color filter, at least part of the color filter having a function as a photoelectric conversion element.

2. The display apparatus according to claim 1, wherein a region of the color filter having a function as a photoelectric conversion element contains a sensitizing dye.

3. The display apparatus according to claim 1, wherein a display element transistor connected to the display element and a light-receiving element transistor connected to the region of the color filter having the function as the photoelectric conversion element are formed on the same surface of a substrate, and the color filter is formed on the display element transistor and the light-receiving element transistor with an insulating layer in between.

4. The display apparatus according to claim 1, wherein a display element transistor connected to the display element is formed on a substrate, and the color filter and a light-receiving element transistor connected to a region of the color filter having a function as a photoelectric conversion element are formed on the display element transistor with an insulating layer in between.

5. The display apparatus according to claim 1, wherein a display element transistor connected to the display element is formed on one of a pair of substrates, and the color filter and a light-receiving element transistor connected to a region of the color filter having a function as a photoelectric conversion element are formed on the other of the pair of substrates.
